(19) United States
(12) Patent Application Publication
(10) Pub. No.: US 2002/0041725 A1
(43) Pub. Date: Apr. 11, 2002

(54) Optical transmitter with back facet monitor

(76) Inventor: Kieran James Patrick Carroll, Abingdon (GB)

Correspondence Address: FLESHNER & KIM, LLP, P.O. Box 221200, Chantilly, VA, 20153-1200, US

(21) Appl. No.: 09/964,870

(22) Filed: Sep. 28, 2001

(30) Foreign Application Priority Data
Jun. 23, 1999 (GB) 9914512.0

(51) Int. Cl. G02B 6/12; G02B 6/30

(52) U.S. Cl. 385/14; 385/49; 216/24

(57) ABSTRACT

The transmitter comprises a laser diode (1) having a front and back emission facets, the laser diode (1) being mounted within a location recess (2) formed in an optical chip (3). The recess (2) has an inclined reflective facet (2C) at one end, an optical waveguide (4) adjacent the other end and support surfaces (8A,8B) on which the laser diode (1) is directly supported and which determines the position of the laser diode (2) in a vertical direction, i.e. a direction perpendicular to the plane of the chip so the front facet of the laser diode (1) is aligned with the optical waveguide (4) and the back facet is simultaneously aligned with the reflective facet(2C). The reflective facet is arranged to receive light directly from the back emission facet and reflect the light out of the plane of the chip (3) to a photodiode (7) acting as a back facet monitor. The chip is preferably a silicon-on-insulator chip and the position of the support surface (2A) determined by the position of an interface between the insulating layer thereof and either the adjacent silicon layer or substrate. A method of forming the location recess (2) is also described.

### TECHNICAL FIELD

This invention relates to a method of forming an optical transmitter with a back-facet monitor, for example as used to provide optical signals for transmission along optical fibres in an optical fibre communication system, and to such an optical transmitter.

### BACKGROUND ART

Known optical transmitters with back-facet monitors for monitoring the output of the transmitter suffer from fabrication problems leading to a wide variation in device parameters, such as tracking error and monitor currents, and/or a high rejection rate for devices not meeting the required specifications. In known devices, a laser diode is mounted on pre-deposited solder on a level surface of the chip which gives rise to vertical alignment problems as the solder flows or cools. The vertical alignment, i.e. in a direction perpendicular to the plane of the chip, between the laser diode and a waveguide positioned to receive light from the front facet of the laser diode and between the laser diode and a back-facet monitor positioned to receive light from the back facet of the laser diode is thus subject to substantial variations.

It is also known to monitor the output of a light source by monitoring the output from the front facet thereof rather than the rear facet by tapping off a small percentage of the light from the front facet and directing this to a monitor photodiode as described in WO98/35253. This is satisfactory in some applications but, in high speed applications, i.e. applications with a high throughput of optical signals, the unconventional pin arrangement required for electrical contact to the device can lead to problems. Furthermore, monitoring of light emitted by the front facet in this way cannot be done without affecting the power output of the device and may also perturb the output signal. It is also undesirable in some applications to provide a relatively long length of waveguide in front of the light source for tapping off of a fraction of the output of the light source due to size constraints and/or the attenuation caused by such a waveguide.

The present invention aims to overcome these disadvantages.

### DISCLOSURE OF THE INVENTION

According to a first aspect of the invention, there is provided a method of forming an optical transmitter comprising the steps of:

selecting a silicon-on-insulator chip comprising a layer of silicon separated from a substrate by an insulating layer;

etching away a selected region of the silicon layer down to the insulating layer to form a location recess in the chip, with one end of the location recess defining the position of a reflective facet and the other end of the location recess being located relative to the position of an optical waveguide;

removing at least part of the exposed insulating layer within the location recess;

anisotopically etching the substrate revealed by removal of the said part of the insulating layer to form a second recess with a support area on opposite sides thereof, and to form the reflective facet at the said one end of the location recess;

providing an electrical contact and solder or other mounting material in the second recess; and

mounting a light source having a front emission facet at one end thereof and a back emission facet at the other end thereof directly on the support area so as to determine the position of the light source in a direction perpendicular to the plane of the chip, and aligning the light source so that the front facet is aligned with the optical waveguide and the back facet is aligned with the reflective facet which is thus positioned to receive light directly from the back emission facet and reflect said light out of the plane of the chip.

According to a second aspect the present invention, there is provided an optical transmitter comprising a light source having a front emission facet at a first end thereof and a back emission facet at a second end thereof, the light source being mounted within a location recess formed in an optical chip, the recess having a reflective facet at one end thereof, an optical waveguide adjacent the other end thereof and a support surface on which the light source is directly supported and which determines the position of the light source in a direction perpendicular to the plane of the chip so the front facet of the light source is aligned with the optical waveguide and the back facet is aligned with the reflective facet, whereby the reflective facet is arranged to receive light directly from the back emission facet and reflect said light out of the plane of the chip.

The light source can thus be simultaneously and accurately aligned in a vertical direction, i.e. in a direction perpendicular to the plane of the chip, with both the waveguide and the reflective facet.

Preferred and optional features of the invention will be apparent from the following description and from the subsidiary claims of the specification.

### BRIEF DESCRIPTION OF DRAWINGS

The invention will now be further described, merely by way of example, with reference to the accompanying drawings, in which:

FIG. 1 is a schematic plan view of a transmitter according to a first embodiment of the invention; and

FIG. 2 is a schematic side view of the transmitter taken along line A-A in FIG. 1;

FIG. 3 is a schematic side view of a transmitter according to a second embodiment of the invention;

FIG. 4A is a perspective view of the first embodiment but with the light source omitted to show the location recess more clearly and FIG. 4B is an enlarged view of part of the location recess; and

FIGS. 5 and 6 are schematic views corresponding to FIG. 4 for explaining a method of fabricating the location recess.

### BEST MODE OF CARRYING OUT THE INVENTION

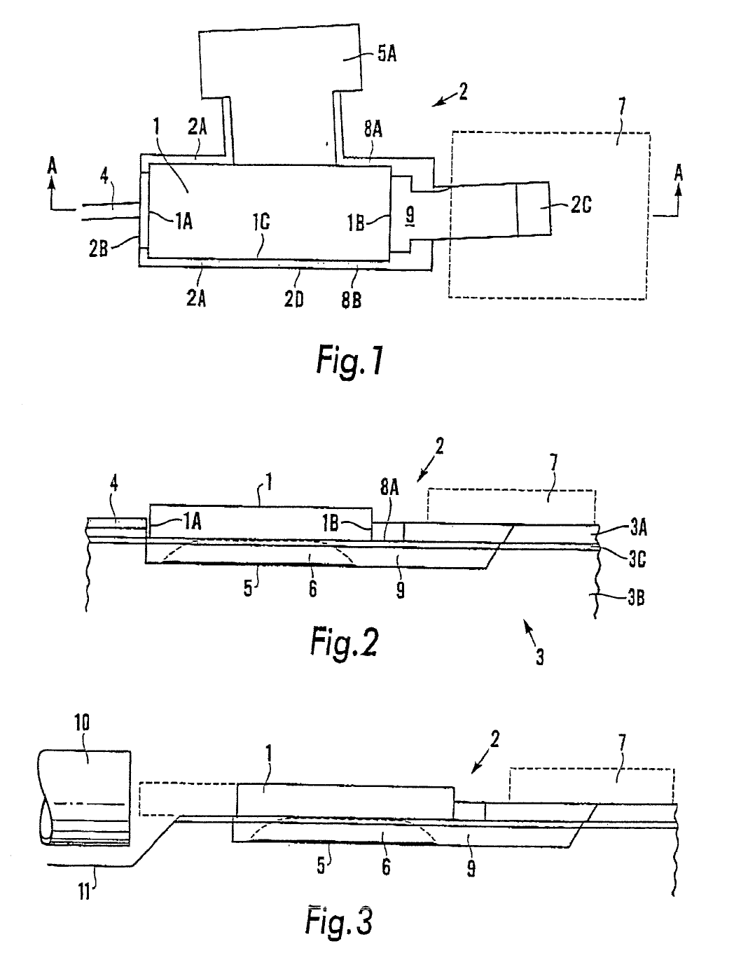

The transmitter shown in FIGS. 1 and 2 comprises a light source in the form of a laser diode 1 mounted within a location recess 2 formed in an optical chip 3. The laser diode has a front facet at one end 1A thereof and a back facet at the other end 1B thereof.

The recess 2 comprises a support surface 2A at the bottom thereof on which the laser diode 1 is directly supported. The support surface is parallel to the plane of the chip 3 and the optical axis of the laser diode 1. The recess also has an end face 2B at one end thereof which is perpendicular to the plane of the chip 3 and an end face 2C at the other end thereof which is inclined to the perpendicular to the plane of the chip 3. The inclined end face 2C comprises a reflective facet the purpose of which will be described below.

A waveguide in the form of a rib or ridge waveguide 4 is integrated in the surface of the chip 3 and leads from the end face 2B of the recess to an optical fibre (not shown) mounted within a V-groove (not shown) formed in the chip 3. Suitable connections between the waveguide and the optical fibre are described in WO97/42534 and in GB9809460.0 (publication No 2334344). The waveguide 4 may also lead to other optical components (not shown) provided on or off the chip 3.

A light detector in the form of a photodiode 7 (shown by dashed lines) is mounted on the chip 3 so as to be positioned over the inclined end face 2C of the recess 2.

The recess 2 is formed such that the support surface 2A is accurately positioned so that when the laser diode 1 is supported thereon, the front facet is accurately aligned with the waveguide 4 in the direction perpendicular to the plane of the chip 3 and the back facet is accurately aligned with the inclined end face 2C of the recess in the direction perpendicular to the plane of the chip 3.

Light emitted from the front facet of the laser diode 1 is thus transmitted along the waveguide 4 to the optical fibre and light emitted from the back facet of the laser diode is received directly by the inclined end face 2C and is reflected thereby to the photodiode 7. The photodiode 7 can thus be used to monitor the output from the back facet of the laser diode 1 and hence monitor the output of the front facet (as there is a known relationship between the outputs from the two facets).

The arrangement described has the advantage of accurately locating the laser diode 1 in the direction perpendicular to the plane of the chip 3. Furthermore, as the support surface 2A and the inclined facet 2C are part of the same recess 2, their positions can be easily and accurately determined relative to each other. The alignment of the waveguide 4 in a direction perpendicular to the optical axis and parallel to the plane of the chip relative to the reflective facet 2C can thus also be easily and accurately determined. These features are typically formed by a photolithography and their positions may be determined in the same photolithographic step.

As shown in FIG. 1, the optical axis of the laser diode 1 is preferably inclined by a few degrees to the optical axis of the waveguide 4 to help reduce interference caused by back reflections at the interfaces therebetween. The waveguide 4 and the reflective facet 2C are preferably formed by an isotropic-etching process so their structure follows crystallographic planes within the chip 3. This results in the location recess 2 being formed at a small angle to a crystallographic axis.

In a preferred embodiment, the chip 3 comprises silicon and in a most preferred embodiment is a silicon-on-insulator chip comprising a layer 3A of silicon separated from a substrate 3B by a layer of insulating material 3C, e.g. silicon dioxide. The position of the support surface 2A can be determined by the position of an interface between the silicon layer 3A and the insulating layer 3C or by the position of an interface between the substrate 3B and the insulating layer 3C. This is advantageous as either interface forms an etch stop when a selective etchant is used, e.g. an etchant which rapidly attacks silicon but only attacks silicon dioxide very slowly, and because the position of these interfaces can be accurately determined. In the first arrangement, the support surface 2A is thus provided by the upper surface of the silicon dioxide layer (as shown in the figures). In the second arrangement, the support surface 2A is provided by the upper surface of the substrate 3B. In the latter arrangement, further adjustment of the height of the support surface 2A can be provided by further etching of the substrate, which is typically formed of silicon. If only a small depth of the substrate is removed in this way, the accuracy of the position of the support surface is not lost as the duration of a short etch can be accurately controlled. In the latter arrangement, the surface of the substrate would usually be re-oxidised to provide an oxide layer thereon of known thickness. Such adjustments are desirable to accommodate light sources of slightly different dimensions.

The position of the laser diode 1 in a direction parallel to the optical axis may, if desired, also be determined by abutting the end face 1A of the laser diode against the end face 2B of the recess 2. Other location means formed on the chip may also be used in place of the end face 2B.

It should be noted that provision of a space between the end face 1 B of the laser diode 1 and the reflective facet 2C allows laser diodes of different lengths to be accommodated in the device. This is of importance as there can be considerable variations in the lengths of the laser diodes used. If it were necessary to locate the laser diode between a waveguide receiving light from the front facet and another waveguide receiving light from the rear facet, problems would arise in accurately matching the dimensions of the laser diode with the spacing between the two waveguides.

The position of the laser diode 1 in a direction perpendicular to its optical axis and parallel to the plane of the chip may be determined simply by accurate placement of the diode relative to the waveguide. However, if desired, it can also be accurately located in this direction by abutting a side face 1C of the diode against a side face 2D of the recess 2. Other location means formed on the chip 3 may also be used in place of the side face 2D. It will be appreciated that to achieve accurate alignment of the front facet of the laser diode 1 with the waveguide 4 by this method requires the laser diode 1 to be provided with a side face 1C which is spaced at an accurately determined distance from the front facet of the laser diode.

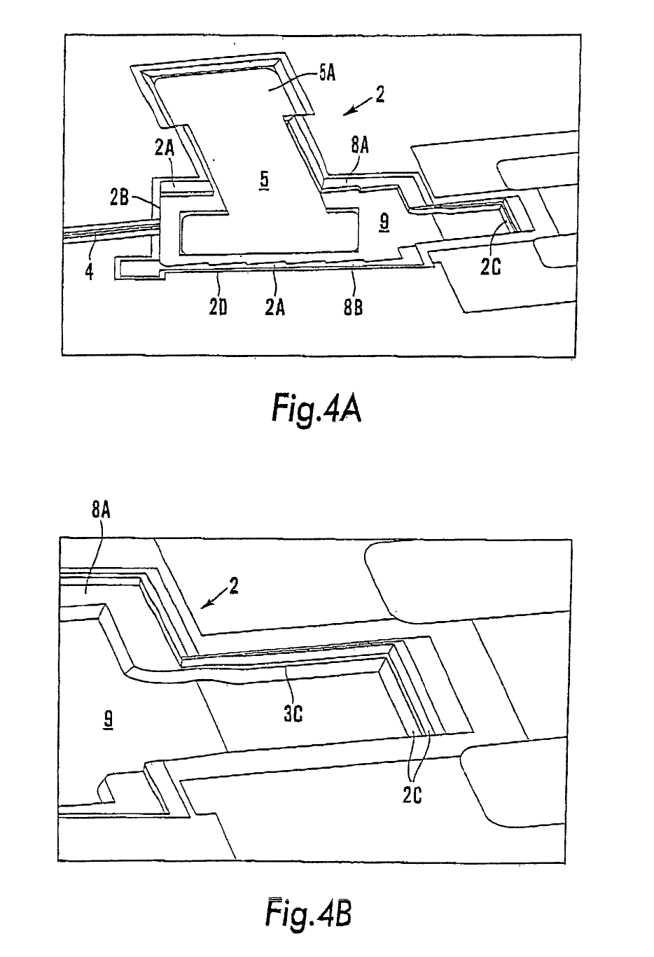

The support surface 2A preferably comprises two spaced-apart portions 8A, 8B with a further recess 9 therebetween for receiving an electrical contact 5 and solder 6 or other mounting material (shown by dashed lines in FIG. 3) for securing the laser diode 1 to the chip 3. The solder 6 thus contacts the underside of the diode 1 but is not present between the laser diode 1 and the support portions 8A and 8B and so does not affect the accurate location of the laser diode in the vertical direction. The portions 8A and 8B may be in the form of steps or ledges on opposite sides of the location recess 2 as shown in FIGS. 2 and 4 but other arrangements can be used. The electrical contact 6 extends to a wirebond area 5A formed in communication with one side of the recess 2.

As indicated above, the waveguide 4 may be a rib waveguide integrated in the silicon layer. In an alternative arrangement shown in FIG. 3, the waveguide comprises an optical fibre 10 mounted within a groove 11 formed in the chip 3. Thus, in this case, light emitted from the front facet of the laser diode 1 enters the optical fibre 10 directly without the need for an integrated waveguide between the laser diode and the fibre. If the groove 11 has an inclined end face, the laser diode 1 is preferably mounted on the chip 3 so as to overlap the inclined end face (as shown by dashed lines in FIG. 3) so the front facet of the diode 1 can be positioned in close proximity with an end face of the optical fibre 10. A suitable arrangement for achieving this is described in GB9811358.2 (Publication No. GB 2335504). Alternatively, or additionally, a lensed fibre may be used with the lensed region partially overlapping the inclined end face of the V-groove 11 and improving the optical coupling with the laser diode 1.

Stops (not shown), e.g. in the form of projections provided on the side faces of the V-groove 11, may also be provided for determining the location of the end of the fibre 10 along the optical axis in the direction towards the laser diode 1 and/or for determining the location of the laser diode 1 along the optical axis in a direction towards the optical fibre 10.

A metal coating, e.g. of aluminium or gold, may be provided on the inclined facet 2C to increase its reflectivity.

FIG. 4A shows a perspective view of the location recess 2 of the device shown in FIG. 1 and 2. The laser diode 1 and photodiode 7 are omitted for clarity.

FIG. 4A shows the support portions 8A and 8B either side of the further recess 9 formed therebetween and shows an electrical contact 5 in the form of a thin metal coating provided on the bottom of the recess 9 and extending out of a side of the location recess 2 to a wirebond area 5A. As described further below, the location recess 9 is preferably formed by an isotropic etching technique, such as plasma etching, so the side walls, e.g. 2B and 2D, of the recess are straight and are formed perpendicular to the plane of the chip. The further recess 9 (and the reflective facet 2C) are however, defined by an anisotropic etching technique, e.g. wet etching. This results in the side walls 9A,9B (see FIG. 6) of the further recess 9, which define edges of the support areas 8A and 8B, being inclined to the perpendicular to the plane of the chip and having a slight saw-tooth shape (as shown in FIG. 4A) as the side walls 9A,9B of the recess 9 are at a slight angle to a crystallographic axis of the chip.

FIG. 4B shows that there is a small step part way down the reflection facet 2C at the level of the insulating layer 3C. This is due to a small offset in the lithographic masks used during the fabrication process but has a negligible effect on the reflective properties of the facet.

A method of forming the location recess 2 in a silicon-on-insulator chip will now be further described with reference to FIGS. 4A, 4B, 5 and 6.

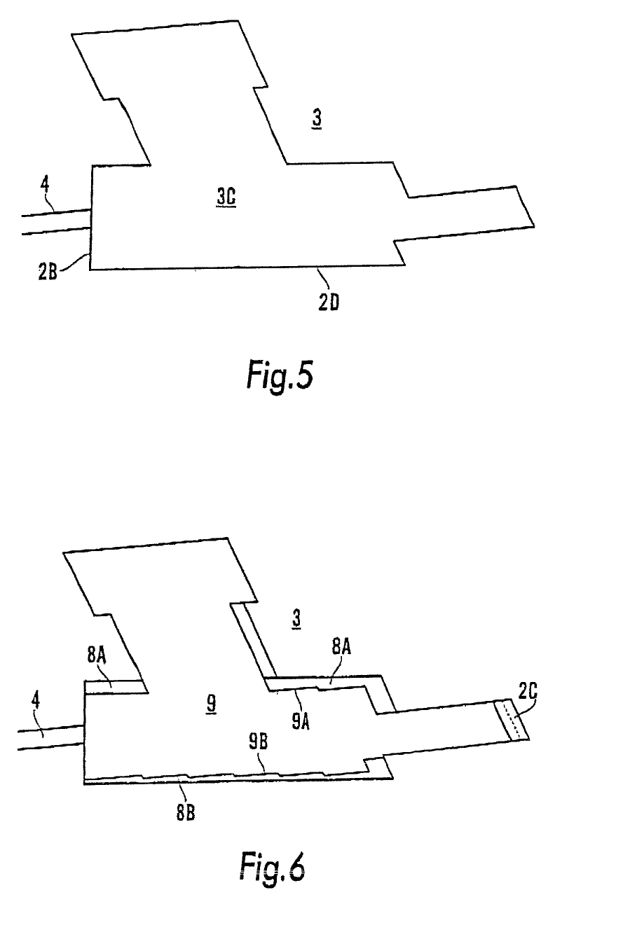

The position of the location recess, with one end thereof defining the position of the reflective facet and the other end thereof being located relative to the position of a waveguide 4, is first defined by etching away a selected region of the silicon layer 3A down to the insulating layer 3C by known lithographic techniques. This results in an area of the insulating layer 3C being revealed as shown in FIG. 5 and the definition of the position of the recess with respect to the waveguide 4 (whether this be the position of a rib waveguide or the position of the V-groove for receiving an optical fibre),. and the definition of the position of the reflective facet 2C. The position of the waveguide 4 may be determined by earlier etching steps (when a rib waveguide is used) or, in some cases, when a fibre in a V-groove is used, by the etching step used to define the position of the location recess Z.

This etching step may, for example, comprise a reactive ion plasma etch so the side walls of the etch are straight, even though they do not lie parallel to a crystallographic axis, and are perpendicular to the plane of the chip 3.

Part of the insulating layer thus exposed is then removed, by known lithographic techniques, to reveal the underlying substrate and define the boundaries of a further etch. A window is thus formed in the insulating layer.

An anisotopic etch is then carried out in which the substrate is etched through the window formed in the insulating layer to form the further recess 9 and to form the inclined end face 2C, leaving support areas 8A and 8B on either side of the recess 9 as shown in FIG. 6, although the mask used for this etch overlaps the boundary of the window at one end thereof to form the inclined end face 2C. The inclined end face 2C thus comprises a lower portion formed in the substrate 3B which falls within the boundary of the first etch shown in FIG. 5 and an upper portion formed in the silicon layer 3A which falls outside this boundary (the location of the boundary being indicated by a dashed line across the inclined end face 2C in FIG. 6).

The anisotopic etch is typically a wet etch which follows crystallographic planes in the silicon. The inclined facet 2C is thus formed at a precisely known angle to the plane of the chip 3 and the side walls 9A and 9B have a slight saw-tooth form as the side walls are inclined by a few degrees to a crystallographic axis of the chip 3.

Having formed the location recess 2 in the manner described above, the electrical contact 5 is deposited on the base of the recess 9 and solder 6 (not shown in FIGS. 4, 5 or 6) is deposited in the recess 9 onto the electrical contact 5. A laser diode 1 is then mounted within the location recess by mounting it directly on the support portions 8A , 8B and ensuring the underside is in contact with the solder 6. The location of the laser diode 1 in the vertical direction is thus determined by the support portions 8A, 8B. Its location is a direction perpendicular to the optical axis but parallel to the plane of the chip 3 may be determined by simply placing it accurately within the recess 2 so the front facet thereof is aligned with the waveguide 4 and the rear facet aligned with the reflective facet 2C. Alternatively, in some cases, a side face 1C of the laser diode 1 may be butted against a side face 2D of the recess (assuming the side face 2D has been formed so as to be straight and vertical) to align the front and rear facets with the waveguide 4 and reflective facet 2C, respectfully.

A photodiode 7 is then mounted over the reflective facet 2C. Light emitted from the back facet of the laser diode is thus received directly by the reflective facet 2C and reflected thereby to the photodiode 7.

It will be appreciated that the above description relates to the fabrication of a device in which the position of the surfaces 8A, 8B are determined by the location of the interface between the silicon layer 3A and the insulating layer 3C. However, further steps may be carried out to etch the oxide layer off the support surfaces 8A, 8B to reveal the underlying substrate and, if desired, to etch a small distance into the substrate and then re-oxide the substrate in order to adjust the height of the support positions 8A,8B.

1. A method of forming an optical transmitter comprising the steps of:
selecting a silicon-on-insulator chip comprising a layer of silicon separated from a substrate by an insulating layer;
etching away a selected region of the silicon layer down to the insulating layer to form a location recess in the chip, with one end of the location recess defining the position of a reflective facet and the other end of the location recess being located relative to the position of an optical waveguide;
removing at least part of the exposed insulating layer within the location recess;
anisotopically etching the substrate revealed by removal of the said part of the insulating layer to form a second recess with a support area on opposite sides thereof, and to form the reflective facet at the said one end of the location recess;
providing an electrical contact and solder or other mounting material in the second recess; and
mounting a light source having a front emission facet at one end thereof and a back emission facet at the other end thereof directly on the support area so as to determine the position of the light source in a direction perpendicular to the plane of the chip, and aligning the light source so that the front facet is aligned with the optical waveguide and the back facet is aligned with the reflective facet which is thus positioned to receive light directly from the back emission facet and reflect said light out of the plane of the chip:

2. A method as claimed in claim 1 in which the support areas are further etched to remove the insulating layer to reveal the substrate, and the light source is mounted directly on the substrate so that its position in a direction perpendicular to the plane of the chip is determined by the location of an interface between the insulating layer and the substrate.

3. A method as claimed in claim 1 in which the support areas are further etched to remove the insulating layer and an accurately controlled depth of the substrate beneath the insulating layer and the substrate is then re-oxidised.

4. A method as claimed in claim 1, 2 or 3 in which the position of the waveguide is defined adjacent to the said other end of the location recess by defining the location of a rib waveguide which terminates adjacent the said other end of the location recess.

5. A method as claimed in claims 1, 2 and 3 in which the position of the waveguide is defined adjacent the said other end of the location recess by defining the location of a V-groove which terminates adjacent the said other end of the location recess and is arranged to receive an optical fibre.

6. A method as claimed in any preceding claim in which the location recess is etched so as to have side surfaces which are substantially perpendicular to the plane of the chip, preferably by means of a reactive ion etch.

7. A method as claimed in claim 6 in which the position of the light source in the direction perpendicular to its optical axis but parallel to the plane of the chip is determined by abutting a side surface of the light source against a side face of the location recess.

8. A method as claimed in any preceding claim in which the insulating layer comprises silicon dioxide and the substrate comprises silicon.

9. An optical transmitter formed by a method as claimed in any preceding claim.

10. An optical transmitter comprising a light source having a front emission facet at a first end thereof and a back emission facet at a second end thereof, the light source being mounted within a location recess formed in an optical chip, the recess having a reflective facet at one end thereof, an optical waveguide adjacent the other end thereof and a support surface on which the light source is directly supported and which determines the position of the light source in a direction perpendicular to the plane of the chip so the front facet of the light source is aligned with the optical waveguide and the back facet is aligned with the reflective facet, whereby the reflective facet is arranged to receive light directly from the back emission facet and reflect said light out of the plane of the chip.

11. An optical transmitter as claimed in claim 10, in which the support surface comprises two portions with a further recess therebetween for receiving solder or other material for securing the light source to the chip.

12. An optical transmitter as claimed in claim 10 or 11, in which the chip comprises a layer of silicon separated from a substrate by an insulating layer.

13. An optical transmitter as claimed in claim 12, in which the position of the support surface in a direction perpendicular to the plane of the chip is determined by the position of an interface between the said layer of silicon and the insulating layer or by an interface between the substrate and the insulating layer.

14. An optical transmitter as claimed in any of claims 10 to 13, in which the position of the light source in a direction perpendicular to its optical axis but parallel to the plane of the chip is determined by abutment of a side surface of the light source against first location means provided on the chip.

15. An optical transmitter as claimed in claim 14, in which the first location means comprises a side face of the location recess.

16. An optical transmitter as claimed in any of claims 10 to 15, in which the position of the light source in a direction parallel to its optical axis is determined by abutment of an end surface of the light source against second locating means provided on the chip.

17. An optical transmitter as claimed in claim 16 in which the second locating means comprises an end face of the location recess.

18. An optical transmitter as claimed in any of claims 10 to 17, in which a light detector is mounted over the said one end of the location recess so as to receive light reflected out of the plane of the chip by the reflective facet.

19. An optical transmitter as claimed in any of claims 10 to 18, in which the relative locations of the optical waveguide and the reflective facet are determined by the same photolithographic step.

20. An optical transmitter as claimed in any of claims 10 to 19, in which the optical waveguide is a waveguide integrated on the chip.

21. An optical transmitter as claimed in claim 20, in which the waveguide is a rib or ridge waveguide.

22. An optical transmitter as claimed in any of claims 10 to 19, in which the waveguide is an optical fibre mounted within a groove formed in the chip.

23. An optical transmitter as claimed in claim 22, in which the groove has an end face which is inclined to the plane of the chip and the light source is mounted on the chip so as to overhang the inclined end face whereby the first emission facet can be positioned in close proximity to an end face of the optical fibre mounted within the groove.

24. An optical transmitter as claimed in any of claims 10 to 23 in which a metal coating is provided on the reflective facet to enhance its reflectivity.

25. An optical transmitter as claimed in any of claims 10 to 24, in which the light source is a laser diode.
